(19) United States
(12) Patent Application Publication
(10) Pub. No.: US 2020/0089933 A1
(43) Pub. Date: Mar. 19, 2020

(54) METHOD OF ACCESSING A FINGERPRINT RECOGNITION PROCESS

(71) Applicant: InnoLux Corporation, Miao-Li County (TW)

(72) Inventor: Chandra LIUS, Miao-Li County (TW)

(21) Appl. No.: 16/132,854

(22) Filed: Sep. 17, 2018

(51) Int. Cl. G06K 9/00; G06K 9/46; H04N 5/57; G06F 3/0488

(52) U.S. Cl. CPC G06K 9/00067; G06F 3/0488; H04N 5/57; G06K 9/4671

(57) ABSTRACT

In a method of accessing a fingerprint recognition process of an electronic device having a display region, it executes the steps of: sensing a contact area of a finger touching the display region; comparing the contact area with a predetermined area; and accessing the fingerprint recognition process when the contact area is greater than the predetermined area.

### BACKGROUND

### 1. Field of the Disclosure

The present disclosure relates to a method of operating an electronic device and, more particularly, to a method of accessing a fingerprint recognition process of an electronic device.

### 2. Description of Related Art

With the rapid advance of electronic technology, the “fingerprint recognition function” has gradually become an essential function of electronic devices. Because the current electronic devices have been generally provided with touch control function, a suitable mechanism for determining the execution timing of the fingerprint recognition is desirable. Otherwise, the electronic device may execute the fingerprint recognition process whenever there is a touch action occurred, resulting in unnecessary power consumption and negatively influencing the execution of the touch control.

Therefore, it is desirable to provide a method of accessing a fingerprint recognition process of an electronic device to solve the aforementioned problem.

### SUMMARY

The present disclosure provides a method of accessing a fingerprint recognition process of an electronic device having a display region, which comprises: sensing a contact area of a finger touching the display region; comparing the contact area with a predetermined area; and accessing the fingerprint recognition process when the contact area is greater than the predetermined area.

The present disclosure also provides a method of accessing a fingerprint recognition process of an electronic device having a display region, which comprises: sensing a contact area and a contact time of a finger touching the display region; comparing the contact area with a predetermined area, and comparing the contact time with a predetermined time; and accessing the fingerprint recognition process when the contact area is greater than the predetermined area or the contact time is greater than the predetermined time.

The present disclosure further provides a method of accessing a fingerprint recognition process of an electronic device having a display region, which comprises: sensing a contact area and a contact time of a finger touching the display region; comparing the contact area with a predetermined area, and comparing the contact time with a predetermined time; and determining whether the predetermined area comprises a plurality of features of the fingerprint; accessing the fingerprint recognition process when the predetermined area comprises the plurality of features of the fingerprint.

Other objects, advantages, and novel features of the disclosure will become more apparent from the following detailed description when taken in conjunction with the accompanying drawings.

### BRIEF DESCRIPTION OF THE DRAWINGS

FIG. 1(A) is a schematic diagram illustrating an electronic device executing a method of accessing a fingerprint recognition process of the electronic device according to an embodiment of the present disclosure;

FIG. 1(B) is a flow chart of the method according to a first embodiment of the present disclosure;

FIG. 2 is a schematic diagram illustrating the internal components of the electronic device according to an embodiment of the present disclosure;

FIG. 3(A) is a flow chart illustrating the detail steps of the method in FIG. 1(B) according to an embodiment of the present disclosure;

FIG. 3(B) is a flow chart illustrating the detail steps of the method in FIG. 1(B) according to another embodiment of the present disclosure;

FIG. 3(C) is a flow chart illustrating the detail steps of the method in FIG. 1(B) according to still another embodiment of the present disclosure;

FIG. 3(D) is a flow chart illustrating detail steps of the step S35 in FIG. 3(C) according to an embodiment of the present disclosure;

FIG. 4 is a flow chart of the method according to a second embodiment of the present disclosure; and

FIG. 5 is a flow chart of the method according to a third embodiment of the present disclosure.

### DETAILED DESCRIPTION OF THE EMBODIMENTS

In the following description, various embodiments will be provided to explain the implementation and operation of the display device of the present disclosure. The person skilled in the art of the present disclosure will understand the features and advantages of the present disclosure through these embodiments. Various combinations, modifications, substitutions or adaptations may be realized based on the present disclosure.

Furthermore, the use of the ordinal numbers such as “first”, “second”, etc. in the specification and claims to modify the elements of the claims do not imply that a claimed element is physically provided with an ordinal number. The ordinal numbers do not represent the order between a claimed element and another claimed element, or the order of a manufacturing method. The use of these ordinal numbers is only for clearly distinguishing a claimed element having a certain name from another claimed element having the same name.

Besides, the term “when . . . ” or “. . . when” is used herein to mean “present, before, or after” and is not limited thereto. In addition, the prepositions mentioned in the present specification and claims, such as “above”, “on”, “upon”, “below”, “beneath” or “under”, may refer to direct contact of two elements, or may refer to indirect contact of two elements. Furthermore, the term “connected” as used herein may refer to direct connection or indirect connection, and is not limited thereto.

The terms “about” and “substantially” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” can mean within one or more standard deviations, or within ±20%, ±15%, ±10%, ±5%, ±3% of the stated value. It is noted that the term “same” may also refer to “about” because of the process deviation or the process fluctuation.

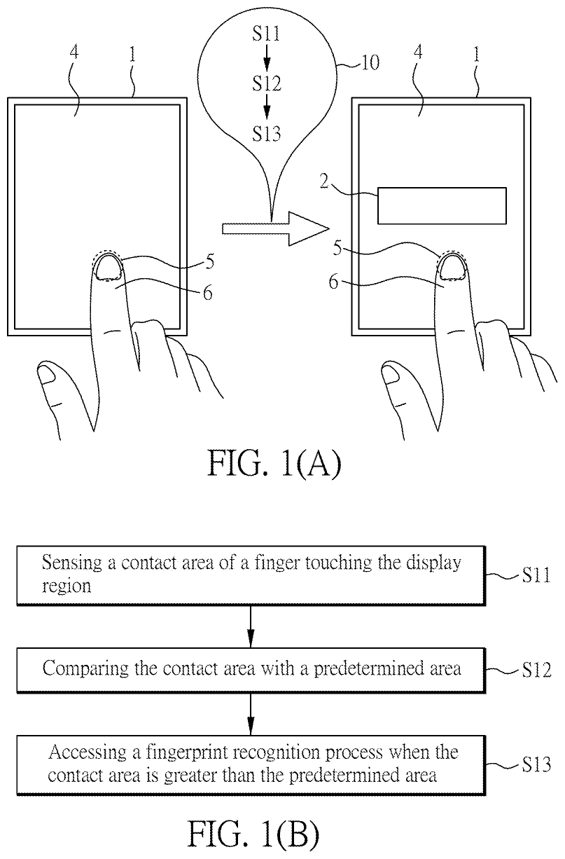

FIG. 1(A) is a schematic diagram illustrating an electronic device 1 executing a method 10 of accessing a fingerprint recognition process 2 of the electronic device 1 according to an embodiment of the present disclosure. FIG. 1(B) is a flow chart of the method 10 according to a first embodiment of the present disclosure. As shown in FIG. 1(A) and 1(B), the electronic device 1 has a display region 4, and the method 10 is executed by the electronic device 1. Besides, the method 10 comprises the steps S11 to S13. The step S11 is provided for sensing a contact area 5 of a finger 6 (i.e., a user's finger) touching the display region 4. The step S12 is provided for comparing the contact area 5 with a predetermined area. The step S13 is provided for accessing the fingerprint recognition process 2 when the contact area 5 is greater than the predetermined area. In an embodiment, “accessing the fingerprint recognition process 2” may be defined as beginning to execute the fingerprint recognition process 2.

It is noted that the method 10 is executed before the fingerprint recognition process 2 is accessed, for determining whether the fingerprint recognition process 2 needs to be executed. In an embodiment, the fingerprint recognition process 2 comprises a data comparing step and a function providing step. In an embodiment, the “data comparing step” may be defined as comparing a fingerprint of the finger 6 with a pre-stored data to authenticate the user's identity, and the “function providing step” may be defined as providing a function (e.g. reading confidential files, executing financial operations, etc.) corresponding to the user's identity, while the present disclosure is not limited thereto. In addition, in an embodiment, the fingerprint recognition process 2 further comprises a data collecting step for collecting a fingerprint data of the finger 6. However, the data collecting step may also be separated from the fingerprint recognition process 2; e.g. the data collecting step may be executed before the fingerprint recognition process 2 is accessed (so that the data collecting step may be regarded as being excluded from the fingerprint recognition process 2).

The predetermined area may comprise a plurality of features of the fingerprint. In one embodiment, the number of the features of the fingerprint increases when the contact area of the finger 6 increases, so the number of the features of the fingerprint may be an index indicating the contact area of the finger 6. Besides, in an embodiment, the features of the fingerprint may be a plurality of minutiae of the fingerprint of the finger 6, but it is not limited thereto.

In order to clearly describe the detail of the present disclosure, the embodiments of the method 10 in the specification are exemplified by the case that there is one single finger touching the display area 4.

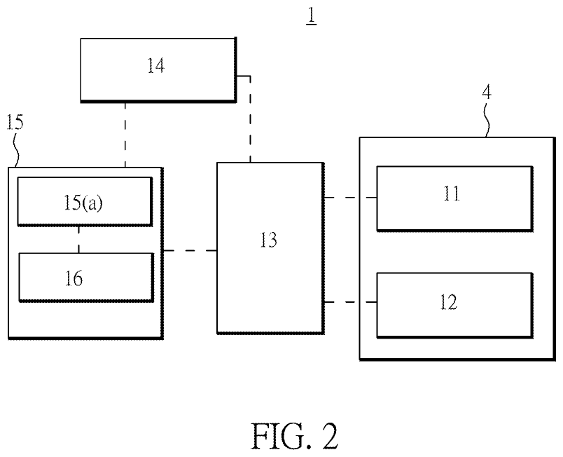

The detail of the electronic device 1 will be described hereinafter. The electronic device 1 can be any device with the fingerprint recognition function, e.g. a display device, an automatic teller machine, etc., but it is not limited thereto. Besides, the display region 4 may be implemented by LCD display technique, OLED display technique, micro LED display technique, mini LED display technique, ?LED display technique or flexible display technique, etc., but it is not limited thereto. The electronic device 1 may include a display medium layer. For example, the display medium layer may include, for example (but not limited to), a liquid crystal layer, a light-emitting diode (LED) layer, an organic light-emitting diode (OLED) layer, an inorganic light-emitting diode layer, a mini light-emitting diode layer, a micro light-emitting diode layer, a quantum-dot layer, a fluorescence layer, a phosphor layer, a display layer of other kinds (e.g. an electro-wetting display layer, an electro-phoresis display layer, a quantum dot display layer, a plasma display layer, etc.), or a combination thereof In examples, the chip size of the inorganic light-emitting diode may be in a range from about 300 μm to 10 mm, the chip size of the mini light-emitting diode may be in a range from about 100 μm to 300 μm, and the chip size of the micro light-emitting diode may be in a range from about 1 μm to 100 μm. The chip sizes of the disclosure are not limited thereto. Besides, FIG. 2 is a schematic diagram illustrating the internal components of the electronic device 1 according to an embodiment of the present disclosure. As shown in FIG. 2, the electronic device 1 may comprise the display region 4, a touch sensor module 11, a fingerprint sensor module 12, a front-end circuit 13, a memory 14 and a micro-controller 15, while the present disclosure is not limited thereto. In some examples, the touch sensor module 11 and the fingerprint sensor module 12 may be integrated into one sensor module. Therefore, the touch function and the fingerprint sensing function may be performed by the integrated sensor module. In this case, the touch sensor module 11 and the fingerprint sensor module 12 described in the present disclosure may be considered as a portion of the integrated sensor module, and some components of the integrated sensor module. In an embodiment, the touch sensor module 11 may comprise a plurality of touch electrodes disposed in the display region 4 for sensing a touch on the display region 4. The fingerprint sensor module 12 may comprise at least a fingerprint sensor disposed in the display region 4 for sensing the fingerprint data of the finger 6 touching the display region 4. The front-end circuit 13 is used to receive the data sensed by the touch sensor module 11 or the fingerprint sensor module 12, and may convert the data from analog signal to digital signal. The memory 14 may store the converted data. The micro-controller 15 may control the executions of the touch sensor module 11 and the fingerprint sensor module 12, and the micro-controller 15 may comprise a microprocessor 15(a) for analyzing the converted data. In an embodiment, the memory 14 may store the predetermined area or a predetermined time, and the microprocessor 15(a) may compare the contact area 5 with the predetermined area, or compare a contact time of the finger 6 contacting the display region 4 with the predetermined time. In addition, the detail of “how the touch sensor module 11 senses the touch” or “how the fingerprint sensor module 12 senses the fingerprint” may be implemented by the person skilled in the art, and thus a detailed description therefore is deemed unnecessary.

In an embodiment, the touch sensor module 11 may be a resistive touch sensing module, a capacitive touch sensing module, an ultrasonic touch module, or an optical touch sensing module, etc., and it is not limited thereto.

In an embodiment, the fingerprint sensor of the fingerprint module 12 may be an optical fingerprint sensor, an ultrasonic fingerprint sensor, or a capacitive fingerprint sensor, and it is not limited thereto. Besides, the fingerprint sensor may have different sizes, thus a fingerprint sensing region provided by the fingerprint sensor on the display area 4 may have different sizes. In an embodiment, the fingerprint sensor may be a local size in-display fingerprint sensor, a half screen in-display fingerprint sensor or a full screen in-display fingerprint sensor. The local size in-display fingerprint sensor may provide the fingerprint sensing region with a size substantially equal to the size of a finger, such as between 1% and 19% of the display region 4. In examples, the fingerprint sensing region of the local size in-display fingerprint sensor may be in a range from 9 mm² to 400 mm² (i.e., 9 mm²≤the size of the fingerprint sensing region≤400 mm²), while the present disclosure is not limited thereto.

The half screen in-display fingerprint sensor may provide the fingerprint sensing region with a size close to half of the display region 4, such as between 20% and 70% (20%≤size≤70%) of the display region 4. For example, the full screen in-display fingerprint sensor may provide the fingerprint sensing region with a size substantially equal to the display region 4, such as between 71% and 100% (71%≤size≤100%) of the display region 4.

Please refer to FIG. 1(A) to FIG. 2. In an embodiment, the steps of the method 10 may be implemented as a plurality of instructions of a non-transitory computer program product 16; for example, the steps may be implemented as a plurality of program codes. The computer program product 16 may be integrated into the micro-controller 15 in a firmware manner. Alternatively, the computer program product 16 may be stored in the memory 14, and may be accessed by the microprocessor 15(a), while it is not limited thereto. In an embodiment, the microprocessor 15(a) may execute the computer program product 16, and the micro-controller 15 may control the electronic device 1 to execute the method 10, while the present disclosure is not limited thereto.

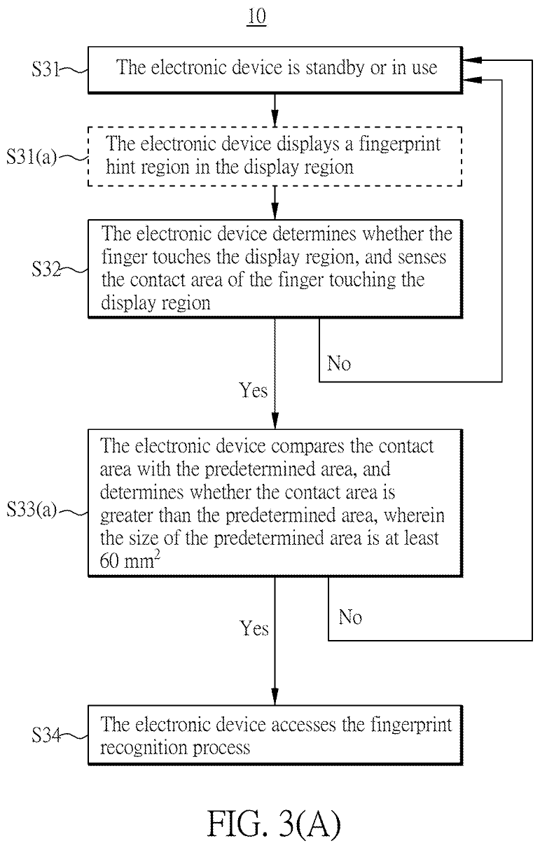

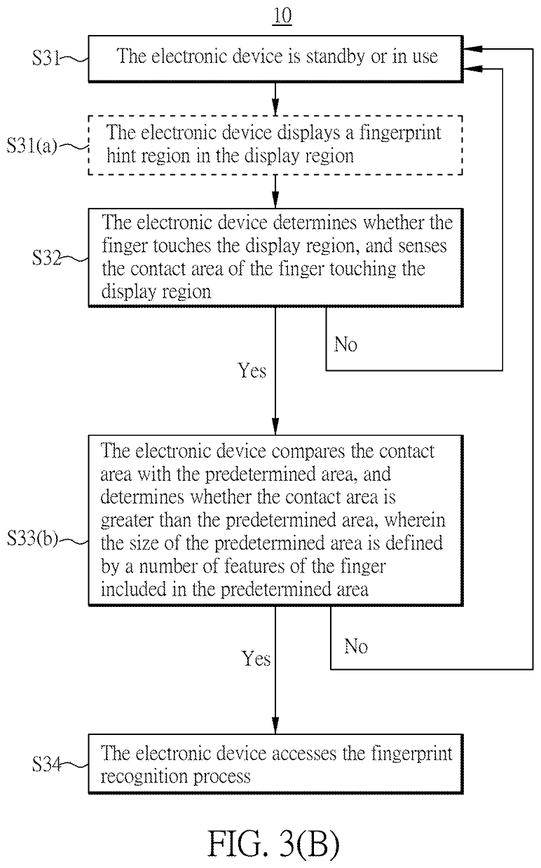

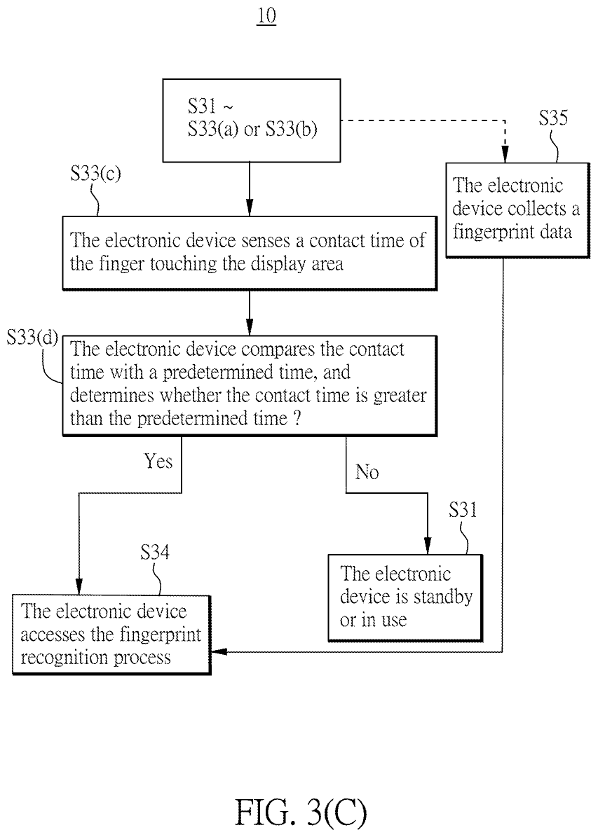

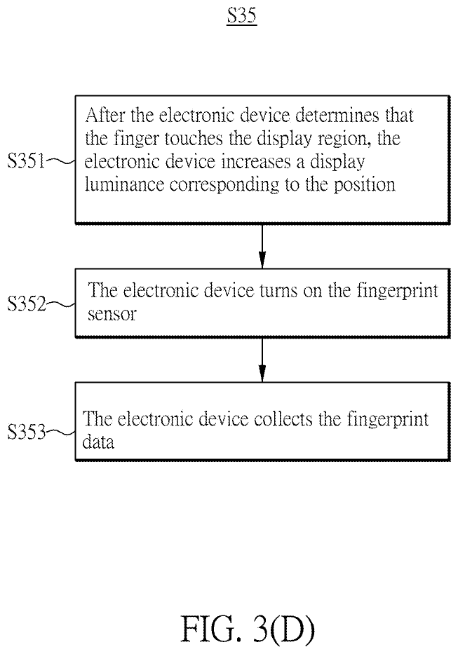

The detail of the method 10 will be described hereinafter. FIG. 3(A) is a flow chart illustrating the detail steps of the method 10 in FIG. 1(B) according to an embodiment of the present disclosure. At first, step S31 may be performed, in which the electronic device 1 is standby or in use. In other example, the electronic device 1 may be in an off-state. Then, step S32 is performed, in which the electronic device 1 determines whether the finger 6 touches the display region 4 and senses the contact area 5 of the finger 6 touching the display region 4. If the electronic device 1 determines that the finger 6 doesn't contact the display region 4, the step S31 may be performed again. If the electronic device 1 determines the finger 6 touches the display region 4 (e.g., the contact area 5 is sensed by the electronic device 1), the step S33(a) will be executed, in which the electronic device 1 compares the contact area 5 with the predetermined area, and determines whether the contact area 5 is greater than the predetermined area, wherein the size of predetermined area may be at least 60 mm⁻. If the contact area 5 is not greater than the predetermined area, the step S31 will be performed again. If the contact area 5 is greater than the predetermined area, the step S34 will be performed, in which the electronic device 1 accesses the fingerprint recognition process 2.

Please refer to FIG. 1(A) to FIG. 3(A). At first, the detail of the step S31 will be described. In an embodiment, “the electronic device 1 is standby” may be defined as a state that the electronic device 1 is waiting for an instruction from the user after the electronic device 1 is powered on. “The electronic device 1 is in use” may be defined as a state that the electronic device 1 is in operation, e.g., a state that the electronic device 1 is controlled by the user or a state that an APP requests the fingerprint recognition, etc., while the present disclosure is not limited thereto.

Then, the detail of the step S32 will be described. In an embodiment, the electronic device 1 executes the step S32 in a particular condition, wherein “the particular condition” may be defined as the electronic device 1 being transited from being standby to being in use, the electronic device 1 starting to execute an APP, or the APP being ready to provide a function related to fingerprint recognition, etc., but it is not limited thereto.

Besides, in an embodiment, the electronic device 1 can determine whether the finger 6 touches the display region 4 by using the touch sensor module 11 to sense a touch on the display region 4 or using the fingerprint sensor module 12 to sense the contact area 5, etc., but it is not limited thereto. In addition, in an embodiment, the electronic device 1 may turn on the fingerprint sensor module 12 after the electronic device 1 determines that the finger 6 touches the display region 4, so as to reduce the power consumption of the electronic device 1 and thereby improve the executing efficiency of the fingerprint sensor module 12.

Then, the detail of the step S33 will be described. In an embodiment, the size of the contact area 5 can be acquired at least by using the fingerprint sensor module 12 to detect the edge of the contact area 5. In an embodiment, the size of the predetermined area is at least 60 mm² (i.e., 60 mm²≤the predetermined area) In an embodiment, the size of the predetermined area is in a range between 60 mm² and 400 mm² (i.e., 60 mm²≤the predetermined area≤400 mm²).

Because the area of a fingerprint of a human being is usually in a range between 60 mm² and 400 mm², e.g. 200 mm², the method 10 will be suitable for the fingers with any size when the predetermined area is in a range between 60 mm² and 400 mm². Besides, when the user applies a normal touch action on the display area 4 (e.g., the user slides or clicks on the display region 4 with the finger 6), generally, only a portion of the fingerprint needs to contact the display area 4. Therefore, it can be known that when the touch area 5 is increased, the possibility that the fingerprint recognition process 2 needs to be executed is getting higher. As a result, the size of the touch area 5 can be used as a basis of determining whether the fingerprint recognition process 2 needs to be executed or not.

It should be noted that the size of the predetermined area may be preset in the electronic device 1, or may also be set by the user. Besides, when the electronic device 1 is in use, the size of the predetermined area can be adjusted according to the user's requirement.

Then, the detail of the step S34 will be described. When the electronic device 1 determines that the contact area 5 is greater than the predetermined area (e.g., the contact area >60 mm²), the possibility that the fingerprint recognition process 2 needs to be executed is high, and thus the electronic device 1 will access the fingerprint recognition process 2.

Besides, the method 10 may further comprise step S31(a), in which the electronic device 1 displays a fingerprint hint region in the display region 4 to indicate a correct position of the fingerprint sensing region or a better position of the fingerprint sensing region for a higher resolution or higher accuracy. In an embodiment, the step S31(a) can be executed between the step S31 and S32.

In some examples, the step S31(a) may be suitable for the electronic device 1 with the local size in-display fingerprint sensor. The step S31(a) may lower the possibility that a contact area of the finger 6 on the display region 4 is out of the fingerprint sensing region of the local size in-display fingerprint sensor. In addition, although the step S31(a) may not be a necessary step for the electronic device 1 with the half screen in-display fingerprint sensor or the full screen in-display fingerprint sensor, the step S31(a) may also be executed in some embodiments. For example, when the electronic device 1 needs to change a position for fingerprint recognition on the fingerprint sensing region due to information security, the step S31(a) can be executed, while the present disclosure is not limited thereto.

FIG. 3(B) is a flow chart illustrating the detail steps of the method 10 in FIG. 1(B) according to another embodiment of the present disclosure. As shown in FIG. 3(B), the steps S31 and S32 in this embodiment are similar to the embodiment of FIG. 3(A), and thus a detailed description therefore is deemed unnecessary. Besides, if the electronic device 1 determines that the finger 6 touches the display region 4 (e.g., the contact area 5 is sensed by the electronic device 1), step S33(b) will be performed, in which the electronic device 1 compares the contact area 5 with the predetermined area and determines whether the contact area 5 is greater than the predetermined area, where the size of the predetermined area is defined by a number of features of the fingerprint included in the predetermined area. If the contact area 5 is not greater than the predetermined area, the step S31 will be performed again. If the contact area 5 is greater than the predetermined area, the step S34 will be performed, in which the electronic device 1 accesses the fingerprint recognition process 2.

Please refer to FIG. 1(A) to FIG. 3(B) at the same time. The detail of the step S33(b) will be described. In an embodiment, “the plurality of the features of the fingerprint” may be defined as minutiae of the fingerprint. Because the number of the minutiae of the fingerprint observed by the electronic device 1 is increased when the contact area 5 is increased. The number of the minutiae of the fingerprint can be used as a basis for determining the size of the contact area 5 and for setting the size of the predetermined area.

In some examples, the minutiae of the fingerprint may be loop minutiae, whorl minutiae or arche minutiae, etc.; while it is not limited thereto.

Besides, in an embodiment, the number of the features of the fingerprint (e.g., the number of the minutiae of the fingerprint) included in the predetermined area is greater than or equal to 8 (i.e., 8≤the number of the features). In an embodiment, the at least 8 features may comprise plain arche minutiae, tented trche minutiae, ulnar loop minutiae, radial loop minutiae, double loop minutiae, plain whorl minutiae, central pocket loop whorl minutiae, and accidental whorl minutiae; while it is not limited thereto. The feature of the finger 6 could also be any pattern of the fingerprint particularly belonged to one human individual. When the number of the features is at least 8, the success rate of the data comparing step of the fingerprint recognition process 2 can be improved; e.g., the success rate can be substantially close to 98%. Thus, the step S33(b) can improve the efficiency of the fingerprint recognition process 2.

It should be noted that the number of the features may be preset in the electronic device 1, but may also be set by the user. Besides, when the electronic device 1 is in use, the number of the features can be adjusted according to the user's requirement.

Then, the step S34 will be described. When the electronic device 1 determines that the number of the features of the fingerprint is greater than the predetermined area comprising 8 features of the fingerprint, the possibility that the fingerprint recognition process 2 needs to be executed is relatively high, and thus the electronic device 1 will access the fingerprint recognition process 2.

Besides, before the electronic device 1 accesses the fingerprint recognition process 2, more steps may be added into the method 10 to determine whether the fingerprint recognition process 2 needs to be executed. FIG. 3(C) is a flow chart illustrating the detail steps of the method 10 in FIG. 1(B) according to still another embodiment of the present disclosure.

At first, the steps S31 to S33(a) or the steps S31 to S33(b) are performed. Then, the step S33(c) is performed, in which the electronic device 1 senses a contact time of the finger 6 touching the display region 4. Then, the step S33(d) is performed, in which the electronic device 1 compares the contact time with a predetermined time. If the contact time is not greater than the predetermined time, the step S31 will be performed again. If the contact time is greater than the predetermined time, the step S34 will be performed, in which the electronic device 1 accesses the fingerprint recognition process 2.

Please refer to FIG. 1(A) to FIG. 3(C) at the same time. The steps S31 to S33(a) or S33(b), and the step S34 in this embodiment are similar to the embodiment of FIG. 3(A) or FIG. 3(B), and thus the detailed description therefor is deemed unnecessary.

For the detail of the step S33(c), because the finger 6 may need to be put on the substantially same position for a period of time during the execution of the fingerprint recognition process 2, the contact time can be used as a basis for determining whether the fingerprint recognition process 2 needs to be executed. Besides, in an embodiment, the step S33(c) may also be performed before the step S33(a) or S33(b), while it is not limited thereto. In addition, in an embodiment, when the electronic device 1 fails to sense the contact time (e.g., the sensing fails), the step S31 is executed again. Furthermore, in an embodiment, the contact time may be calculated by at least a timer circuit of the microprocessor 15(a).

For the step S33(d), in an embodiment, due to the execution period of one normal touch action (e.g. sliding or clicking on the display region 4 with the finger 6) is substantially less than 0.3 second, and to lower the possibility that the touch action and the fingerprint recognition process 2 interfere with each other, the predetermined time is at least 0.3 second. In some examples, by setting the predetermined time as at least 0.3 second, when the contact time is greater than 0.3 second and the contact area 5 is less than a predetermined area, the electronic device 1 may not access the fingerprint recognition process 2. In an embodiment, the predetermined time may be in a range from 0.3 seconds to 3 seconds (i.e., 0.3 s≤the predetermined time≤3s). In an embodiment, the predetermined time can be 0.3 seconds, 0.5 seconds or 1 second, while it is not limited thereto.

It should be noted that the predetermined time may be preset in the electronic device 1, but may also be set by the user. Besides, when the electronic device 1 is in use, the predetermined time can be adjusted according to the user's requirement.

Besides, in an embodiment, step S35 may be performed before the step S34. In the step S35, the electronic device 1 collects the fingerprint data of the finger 6. In an embodiment, the fingerprint data may be defined as any data which can be used for the fingerprint recognition process 2; for example, when the fingerprint sensor is the optical fingerprint sensor, the finger data may be a fingerprint image of the finger 6.

It is noted that the step S35 may be performed at any time before the step S34 is performed; e.g., the step S35 may start to be performed when the finger 6 touches the display region 4, such as the step S32.

The detail of the step S35 will be described. FIG. 3(D) is a flow chart illustrating detail steps of the step S35 in FIG. 3(C) according to an embodiment of the present disclosure. At first, the step S351 is performed, in which, after the electronic device 1 determines that the finger 6 touches the display region 4 (e.g., the fingerprint hint region or the contact area 5), the electronic device 1 increases a luminance of a region corresponding to a position of the finger 6 touching the display region 4 (e.g., the finger hint region or the contact area 5). Then, the step S352 is performed, in which the electronic device 1 turns on the fingerprint sensor module 12. Then, the step S353 is performed, in which the electronic device 1 acquires the fingerprint data of the finger 6 by the fingerprint sensor.

Please refer to FIG. 1(A) to FIG. 3(D) at the same time. In an embodiment, “the luminance” may be defined as the backlight brightness of the electronic device 1. In another embodiment, “the luminance” may be defined as the brightness of light-emitting layers in the electronic device 1, e.g. OLED layers, LED layers, etc. In an embodiment, the electronic device 1 can increase the luminance of the region corresponding to the position of the finger 6 touching the display region 4 (e.g., the fingerprint hint region or the contact area 5) by using the local dimming technique. Besides, in an embodiment, the fingerprint sensor can be the optical fingerprint sensor, and the optical fingerprint sensor may acquire the fingerprint data (e.g., the fingerprint image) by receiving reflected light from the finger 6.

With the steps S351 to S353, the electronic device 1 may collect the fingerprint data before the fingerprint recognition process 2 is accessed, so that the total time for the execution of the fingerprint recognition process 2 can be reduced, and the efficiency of the electronic device 1 can be improved.

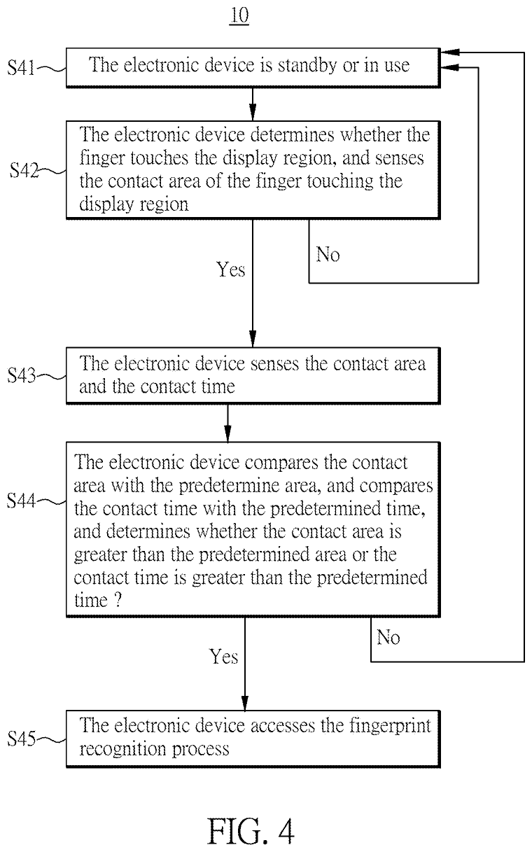

The method 10 of the present disclosure may also be provided with some variations. FIG. 4 is a flow chart of the method 10 according to a second embodiment of the present disclosure. It is noted that some technical features of this embodiment have been described in the embodiments of FIG. 1(A) to 3(D), and thus a detailed description therefor is deemed unnecessary.

As shown in FIG. 4, at first, steps S41 and S42 are performed. Because the steps S41 to S42 are similar to the steps S31 to S32 of FIG. 3(A) and FIG. 3(B), a detailed description therefore is thus omitted. Then, step S43 is performed, in which the electronic device 1 senses the contact area 5 and the contact time. Then, the step S44 is performed, in which the electronic device 1 compares the contact area 5 with the predetermined area, and compares the contact time with the predetermined time. If the contact area 5 is not greater than the predetermined area, and the contact time is not greater than the predetermined time, the step S41 will be performed again. If the contact area 5 is greater than the predetermined area, or the contact time is greater than the predetermined time, the step S45 will be performed, in which the electronic device 1 accesses the fingerprint recognition process 2.

Please refer to FIG. 1(A) to FIG. 4 at the same time. For the steps S43 and S44, in this embodiment, the electronic device not only compares the contact area 5 with the predetermined area, but also compares the contact time with the predetermined time, wherein the aforementioned comparisons are similar to those described in the embodiments of FIG. 3(A), 3(B) and 3(C) and thus a detailed description therefor is deemed unnecessary. Besides, the comparison between the contact area 5 and the predetermined area and the comparison between the contact time and the predetermined time can be synchronously executed, but it is not limited thereto. For the step S45, in this embodiment, if one of the conditions including “the contact area 5 is greater than the predetermined area” and “the contact time is greater than the predetermined time” is satisfied, the electronic device 1 can access the fingerprint recognition process 2.

Similar to the previous embodiments, in an embodiment, the predetermined area may be greater than 60 mm², the predetermined area may comprise at least 8 features of the fingerprint, and the predetermined time may be in a range from 0.3 seconds to 3 seconds, while the present disclosure is not limited thereto.

Besides, the step S31(a) of FIG. 3(A) or the step S35 of FIG. 3(C) and 3(D) can be added into the method 10 of FIG. 4.

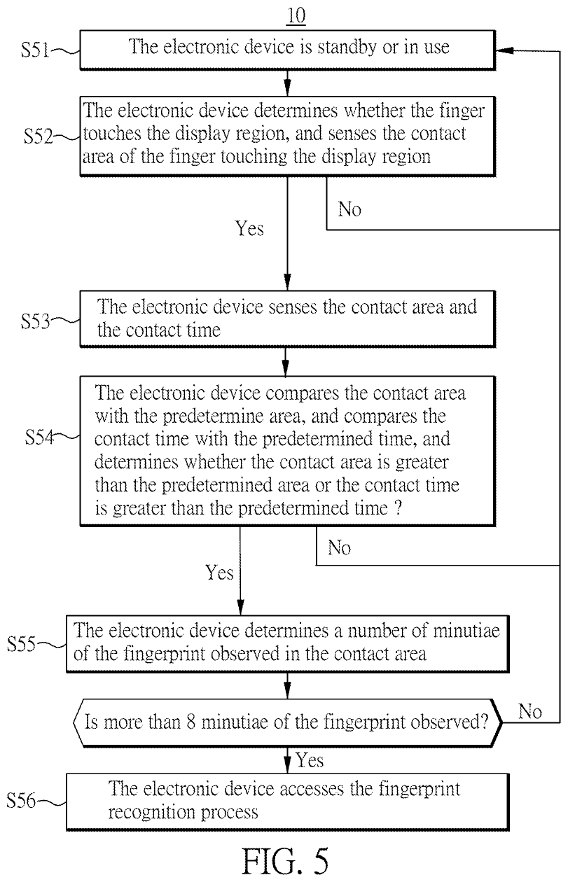

FIG. 5 is a flow chart of the method 10 according to a third embodiment of the present disclosure. It is noted that some technical features of this embodiment have been described in the embodiments of FIG. 1(A) to FIG. 4, and thus a detailed description therefor is deemed unnecessary.

As shown in FIG. 5, steps S51 to S52 in this embodiment are similar to the steps S31 to S32 of FIG. 3(A) and FIG. 3(B), and steps S53 to S54 in this embodiment are similar to the steps S43 to S44 of FIG. 4, so that a detailed description therefor is deemed unnecessary. When the contact area 5 is greater than the predetermined area or the contact time is greater than the predetermined time, the step S55 is performed, in which the electronic device 1 determines a number of the features of the fingerprint within the contact area 5. When the number of the features is not greater than a predetermined number, the step S51 is performed again. When the number of the features is greater than the predetermined number, step S56 is performed, in which the electronic device 1 accesses the fingerprint recognition process 2.

Please refer to FIG. 1(A) to FIG. 5 at the same time. In an embodiment, the electronic device 1 can determine a number of the features within the contact area 5 by using the fingerprint sensor module 12. Besides, in an embodiment, the predetermined number is at least 8, so as to improve the success rate of the fingerprint recognition process 2.

Similar to the previous embodiments, in an embodiment, the predetermined area may be greater than 60 mm², the predetermined area may comprise at least 8 features of the fingerprint, and the predetermined time may be in a range from 0.3 seconds to 3 seconds, while the present disclosure is not limited thereto.

Besides, the step S31(a) of FIG. 3(A) or the step S35 of FIG. 3(C) and 3(D) can be added into the method 10 of FIG. 5.

In view of the foregoing, it is known that the method of accessing a fingerprint recognition process of an electronic device having a display region in accordance with the present disclosure can provide the electronic device with a suitable execution timing of the fingerprint recognition process. Or, the method can solve the problem that the fingerprint recognition process is executed whenever there is a touch action occurred. Or, the method may lower the negative influence to the touch function of the electronic device caused by the fingerprint recognition. Or, the method may improve the efficiency of the fingerprint sensor module. Or, the method may reduce the power consumption of the electronic device.

The embodiments of the present disclosure may be applied to any electronic device that requires a display screen and is provided with a fingerprint recognition function, such as a display device, a mobile phone, a notebook computer, a tablet computer, a watch, a VR display, a video camera, a camera, a music player, a mobile navigation device, a television, a car dashboard, a center console, an electronic rear-view mirror, a head-up display, a cash machine, and so on.

Although the present disclosure has been explained in relation to its preferred embodiment, it is understood that many other possible modifications and variations can be made without departing from the spirit and scope of the disclosure as hereinafter claimed.

What is claimed is:

1. A method of accessing a fingerprint recognition process of an electronic device having a display region, comprising:
sensing a contact area of a finger touching the display region;
comparing the contact area with a predetermined area; and
accessing the fingerprint recognition process when the contact area is greater than the predetermined area.

2. The method of claim 1, further comprising displaying a fingerprint hint region in the display region.

3. The method of claim 1, wherein the predetermined area is greater than 60 mm².

4. The method of claim 1, wherein the predetermined area comprises a plurality of features of the fingerprint.

5. The method of claim 4, wherein a number of the plurality of features is greater than or equal to 8.

6. The method of claim 1, further comprising sensing a contact time of the finger touching the display region and comparing the contact time with a predetermined time before accessing the fingerprint recognition process.

7. The method of claim 6, wherein the predetermined time is in a range from 0.3 seconds to 3 seconds.

8. The method of claim 1, further comprising collecting a fingerprint data before accessing the fingerprint recognition process.

9. The method of claim 8, further comprising:
displaying a fingerprint hint region in the display region before collecting, the fingerprint data; and
increasing a luminance corresponding to the fingerprint hint region.

10. A method of accessing a fingerprint recognition process of an electronic device having a display region, comprising:
sensing a contact area and a contact time of a finger touching the display region;
comparing the contact area with a predetermined area, and comparing the contact time with a predetermined time; and
accessing the fingerprint recognition process when the contact area is greater than the predetermined area or the contact time is greater than the predetermined time.

11. The method of claim 10 , further comprising displaying a fingerprint hint region in the display region.

12. The method of claim 10, wherein the predetermined area is greater than 60 mm².

13. The method of claim 10, wherein the predetermined area comprises a plurality of features of the fingerprint.

14. The method of claim 13, wherein a number of the plurality of features is greater than or equal to 8.

15. The method of claim 10, wherein the predetermined time is in a range from 0.3 seconds to 3 seconds.

16. The method of claim 10, further comprising collecting a fingerprint data before accessing the fingerprint recognition process.

17. The method of claim 16, further comprising:
displaying a fingerprint hint region in the display region before collecting the fingerprint data; and
increasing, a luminance corresponding to the fingerprint hint region.

18. A method of accessing a fingerprint recognition process of an electronic device having a display region, comprising:
sensing a contact area and a contact time of a finger touching the display region;
comparing the contact area with a predetermined area, and comparing the contact time with a predetermined time; and
determining the number of features of the fingerprint within the contact area;
accessing the fingerprint recognition process when the number of features of the fingerprint within the contact area is greater than a predetermined member.

19. The method of claim 18, wherein the predetermined area is greater than 60 mm², and the predetermined number is greater than or equal to 8.

20. The method of claim 18, wherein the predetermined time is in a range from 0.3 seconds to 3 seconds.
